(19) United States
(12) Patent Application Publication
(10) Pub. No.: US 2002/0104709 A1
(43) Pub. Date: Aug. 8, 2002

(54) Tool box mountable on the top step of a foldable ladder

(76) Inventor: Kenneth Joshua Hines, Payson, UT (US)

Correspondence Address: Angus C. Fox, III, 4093 N. Imperial Way, Provo, UT, 84604-5386, US

(21) Appl. No.: 09/777,178

(22) Filed: Feb. 5, 2001

(51) Int. Cl. E06C 5/32

(52) U.S. Cl. 182/129

(57) ABSTRACT

A toolbox fabricated from semi-rigid polymeric material includes a base portion that is strapable to the uppermost step of a folding step ladder, a storage portion unitary with the base portion, and a hinged cover portion which is sized to reversably cover the storage portion. The base portion includes multiple slot-like apertures, through which flexible straps may be inserted. When the toolbox has been mounted on the top step of a step ladder, the straps may be used to secure the toolbox to the step by securing the ends of each strap beneath the step. Though many types of strap fasteners are known in the art, hook and look fasteners are considered to be the most economical means of securing the strap ends. The storage portion of the tool box includes multiple bin-type storage compartments which are intended to store tools, supplies, small equipment and parts for tasks which are typically performed while standing on a ladder. One of the compartments is designed for the temporarily holding of a power tool such as an electric drill in an oblique position. The front lip of the front wall of that compartment is notched, while the rear wall of that compartment contains an aperture, or opening, through which the chuck and attached bit of an electric drill or of some similar tool pistol-shaped electric tool may be inserted.

### FIELD OF THE INVENTION

This invention relates to accessories for step ladders and, more particularly, to a box or caddy for holding tools, parts and supplies, which may be removably attached to the top of a step ladder.

### BACKGROUND OF THE INVENTION

When working on a step ladder, it is often necessary for an individual to have access to various tools (both manual and electric), fasteners, fastener anchors, and other parts and supplies. Heavy tools, such as electric drills or electric screwdrivers are generally used only intermittently and must be laid down and secured when not in use. If such a tool is not secured, it may fall and damage the tool and/or the drill bit or screwdriver bit chucked up in the tool and/or the floor surface. If the floor is made of hardwood strips or tiled, complete repair of the surface may be impossible. This is especially true if a replacement tile having the identical texture and color is not readily available.

Many U.S. patents have been issued on devices which address the heretofore expressed needs. For example, U.S. Pat. No. 5,613,574 discloses a ladder-mountable combined tool holster and parts tray. The device clamps onto the top step of a step ladder. An aperture in the floor of the device is designed to receive the chuck and attached bit of a power tool such as an electric drill. The device may be clamped such that the aperture is on either the right or left side of the uppermost step.

A caddy tray having a top side for receiving individual tools, parts and/or components in prescribed locations is disclosed in U.S. Pat. No. 5,941,344. The underside of the tray is designed to fit over the top of a step ladder. Adjustable straps enable the tray to be releasably secured to the top step.

U.S. Pat. No. 5,505,302 discloses a covered toolbox for a step ladder comprising a container having a holding space therein, and an outwardly extending lip adapted for hanging items thereupon, and a coupling mechanism for securing the tool box to the step ladder.

In U.S. Pat. No. 4,356,854, a cloth work pouch is disclosed that can be draped over the top step of a step ladder. The unit includes a central compartment for tools, equipment and supplies, a skirt which fits around the sides of the step, and a plurality of side pockets for large items, such as power tools.

Another step ladder mountable tool box is disclosed in U.S. Pat. No. 5,603,405.

The tool box, which is fabricated from rigid material, incorporates multiple cloth side pouches, each of which has a zippered opening.

### SUMMARY OF THE INVENTION

The present invention is a toolbox fabricated from semi-rigid polymeric material that includes a base portion for securing the toolbox to the uppermost step of a folding step ladder, a storage portion unitary with the base portion, and a hinged cover portion which is sized to reversably cover the storage portion. The base portion includes multiple slot-like apertures, through which flexible straps may be inserted. When the toolbox has been mounted on the top step of a step ladder, the straps may be used to secure the toolbox to the step by securing the ends of each strap beneath the step. Though many types of strap fasteners are known in the art, hook and look fasteners are considered to be the most economical means of securing the strap ends.

The storage portion of the tool box includes multiple bin-type storage compartments which are intended to store tools, supplies, small equipment and parts for tasks which are typically performed while standing on a ladder. One of the compartments is designed for the temporarily holding of a power tool such as an electric drill in an oblique position. The front lip of the front wall of that compartment is notched, while the rear wall of that compartment contains an aperture, or opening, through which the chuck and attached bit of an electric drill or of some similar tool pistol-shaped electric tool may be inserted.

For a preferred embodiment of the invention, the toolbox is manufactured from a rugged, impact-resistant polymeric “plastic” material such as polyethylene, polypropylene, polycarbonate, or polystyrene. For a toolbox fabricated from polyethylene, the cover portion may be attached to the storage portion via a “live” hinge that is integral with both the storage portion and the cover portion. A live hinge is generally defined as a thin ribbon of flexible material which can be repeatedly flexed without experiencing significant fatigue. Alternatively, the cover portion may include conventional hinges, each of which incorporates a hinge pin. A handle may also be molded unitary with the cover portion, as may be a latch. A clasp may be molded unitary with the storage portion of the toolbox.

### BRIEF DESCRIPTION OF THE DRAWINGS

FIG. 1 is an isometric top-side-rear view of the toolbox with the lid raised;

FIG. 2 is an isometric top-side-front view of the toolbox with the lid raised;

FIG. 3 is a top plan see-through view of the toolbox with the lid raised;

FIG. 4 is a rear-elevational see-through view of the toolbox with the lid raised;

FIG. 5 is a right-side elevational see-through view of the toolbox with the lid raised, the left-side elevational see-through view being a mirror image thereof;

FIG. 6 is an isometric top-side-rear view of the open toolbox, mounted on the uppermost step of a foldable step ladder, said toolbox having an electric drill and chucked bit resting in the right-most storage compartment;

FIG. 7 is an exploded view of the open toolbox and a foldable step ladder; and

FIG. 8 is an assembled view of the toolbox and step ladder of FIG. 7.

### DETAILED DESCRIPTION OF THE PREFERRED EMBODIMENTS

The toolbox will now be described in detail with reference to the attached drawings. The benefits and utility of thereof will be evident to those individuals who frequently work on ladders and have need for readily accessible tools and supplies.

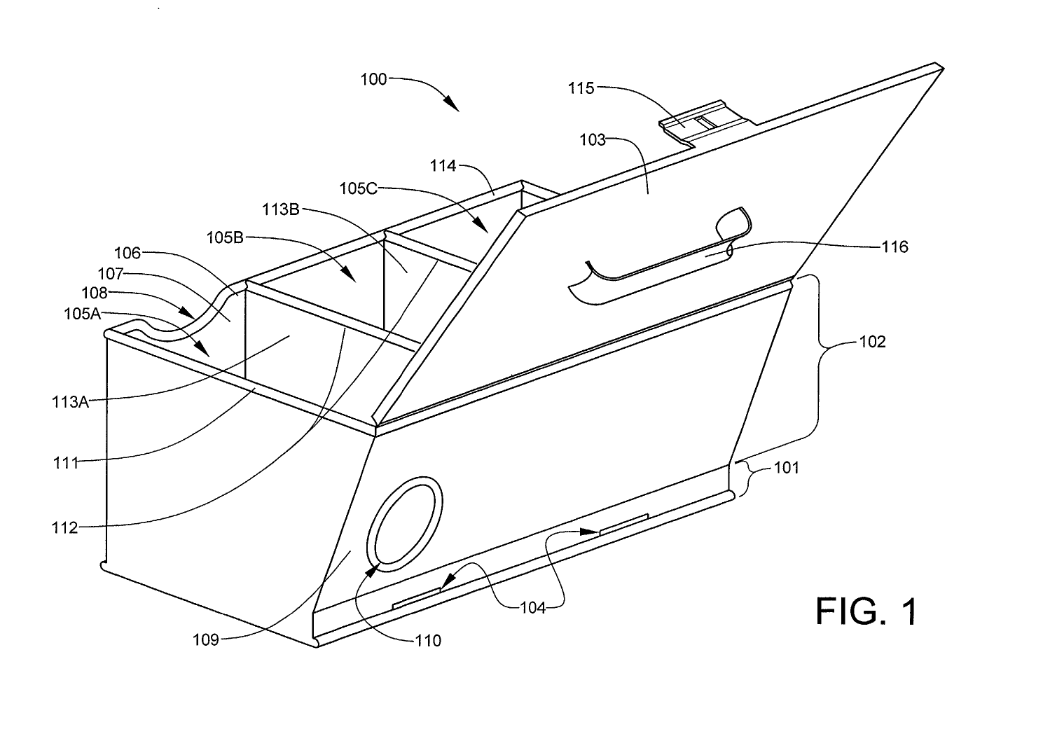

Referring now to FIG. 1, the new step-ladder-mountable toolbox 100 is injection molded from a semi-rigid, impact-resistant, polymeric material such as polyethylene, polypropylene, polycarbonate, or polystyrene. For a preferred embodiment of the invention, polyethylene is the preferred material, as it is highly resistant to bending fatigue. The toolbox 100 includes a base portion 101 for securing the toolbox to the uppermost step of a folding step ladder, a storage portion 102 unitary with the base portion 101, and a hinged cover portion 103, which is sized to reversably cover the storage portion 102. The base portion 101 includes two pair of horizontally-aligned, spaced-apart, slot-like apertures 104, through which flexible straps (not shown in this drawing figure: please refer to FIG. 6) may be inserted. When the toolbox 100 has been mounted on the top step of a step ladder, the straps may be used to secure the toolbox 100 to that step by securing the ends of each strap beneath the step. Though many types of strap fasteners are known in the art, hook and look fasteners are considered to be the most economical means of securing the strap ends.

Still referring to FIG. 1, the storage portion 102 of the tool box 100 includes multiple bin-type storage compartments 105A, 105B and 105C, which are intended to store tools, supplies, small equipment and parts for tasks which are typically performed while standing on a ladder. One of the compartments 105A is designed to not only hold tool, supplies and the like, but also to hold a power tool for use while an individual is standing the one of the lower steps of the ladder. It will be noted that the front lip 106 of the front wall 107 of compartment 105A includes a notch 108, while the rear wall 109 of compartment 105A contains an aperture 110, or opening, through which the chuck and attached bit of an electric drill or of some similar tool pistol-shaped electric tool may be inserted (please refer to drawing FIG. 6), thereby permitting the electric tool to rest in an oblique position. By holding the tool in an oblique position, it is conveniently and easily grasped by the user. It will be noted that the upper perimetric edge 111 of the storage portion 102, the upper edges 112 of the compartment dividers 113A and 113B, and the edges of aperture 110 incorporate a beaded rim 114 of circular cross section for additional strength, rigidity, and reinforcement. It will also be noted that the cover portion 103 incorporates both a latch 115 and a handle 116 both of which, for a preferred embodiment of the invention, are molded unitary with the cover portion 103.

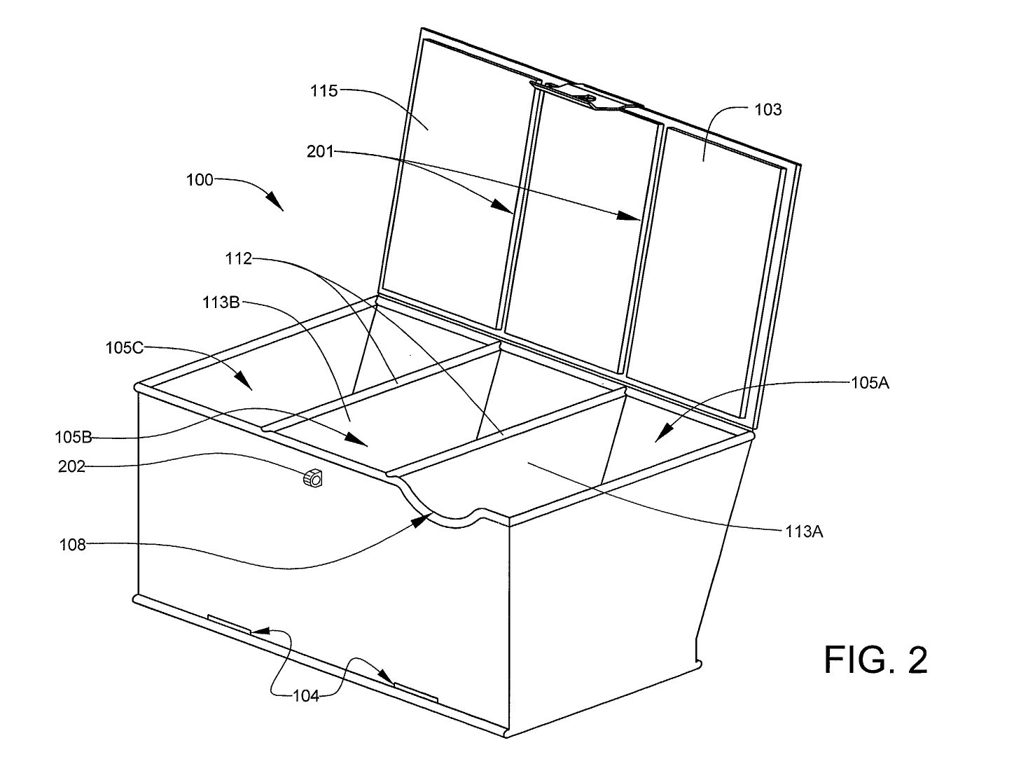

Referring now to FIG. 2, the storage compartments 105A, 105B and 105C are more clearly visible, as are details of construction of the cover portion 103. It will be noted that the cover portion 103 is equipped with grooves 201, which mate with the upper perimetric edge 111 and the upper edges 112 of the dividers 113A and 113B. Also visible in FIG. 2 is a clasp 202, which mates with the latch 115.

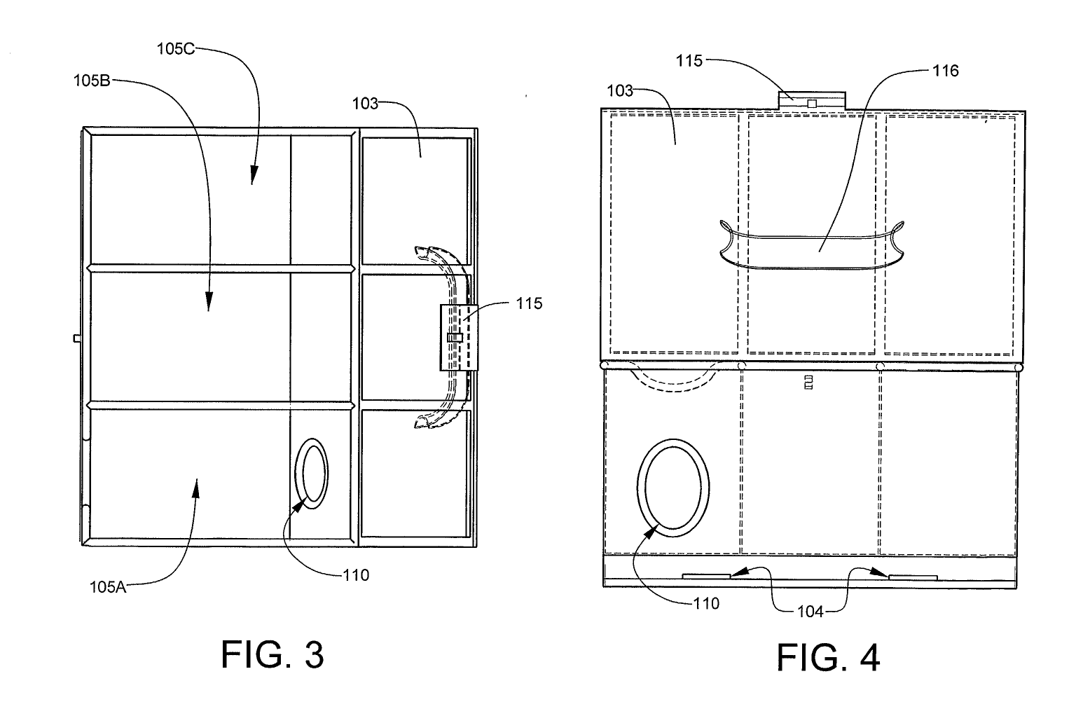

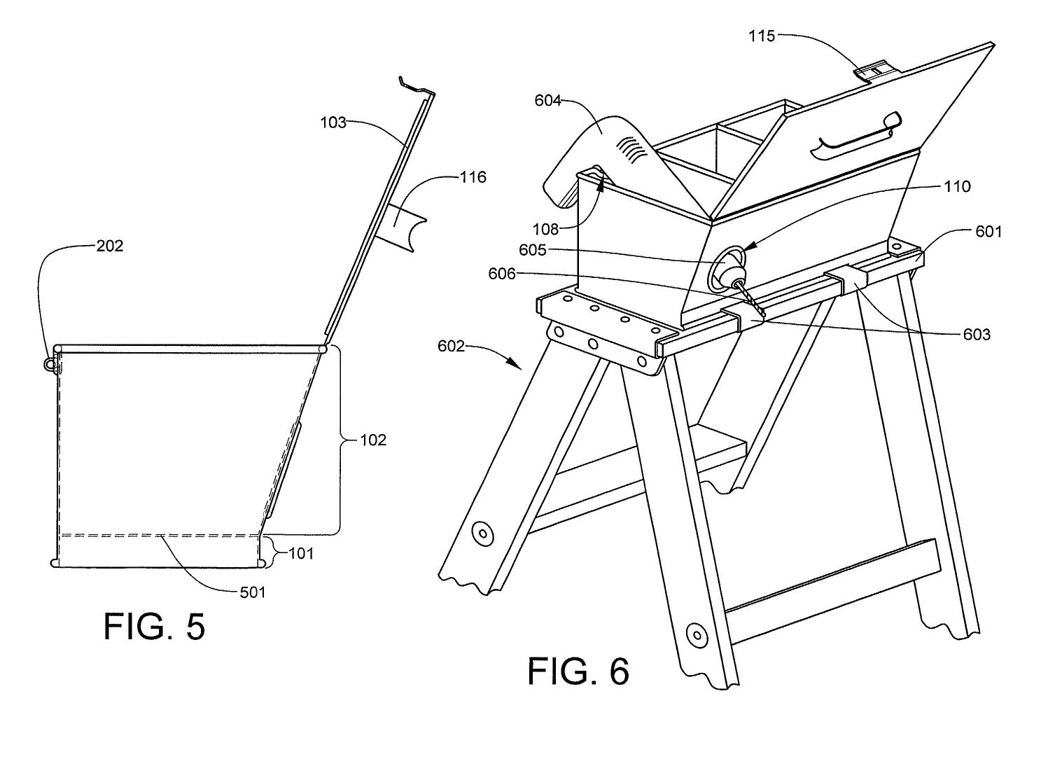

Referring now to FIGS. 3, 4 and 5, certain features are more clearly visible. It will be noted, for example, that the rear wall 109 slopes outwardly to facilitate insertion of the chuck of a power tool into aperture 110. The shape of the handle 116 is also more clearly shown in these views. It will also be noted that for the embodiment of the invention depicted in these drawings, the cover portion 103 is attached to the storage portion 102 via a “live” hinge 301 that is integral with both the storage portion 102 and the cover portion 103. A live hinge is generally defined as a thin ribbon of flexible material which can be repeatedly flexed without experiencing significant fatigue. Alternatively, the cover portion may include conventional hinges (not shown), each of which incorporates a hinge pin. A floor panel 501 (shown by broken, hidden lines in this figure) is shared by the base portion 101 and the storage portion 102.

Referring now to FIG. 6, the toolbox 100 is shown mounted on the uppermost step 601 of a folding step ladder 602. In this view, straps 603 are shown which anchor the toolbox 100 to the uppermost step 601. An electric drill 604 is shown resting in the notch 108, with its chuck 605 and an attached drill bit 606 inserted through aperture 110.

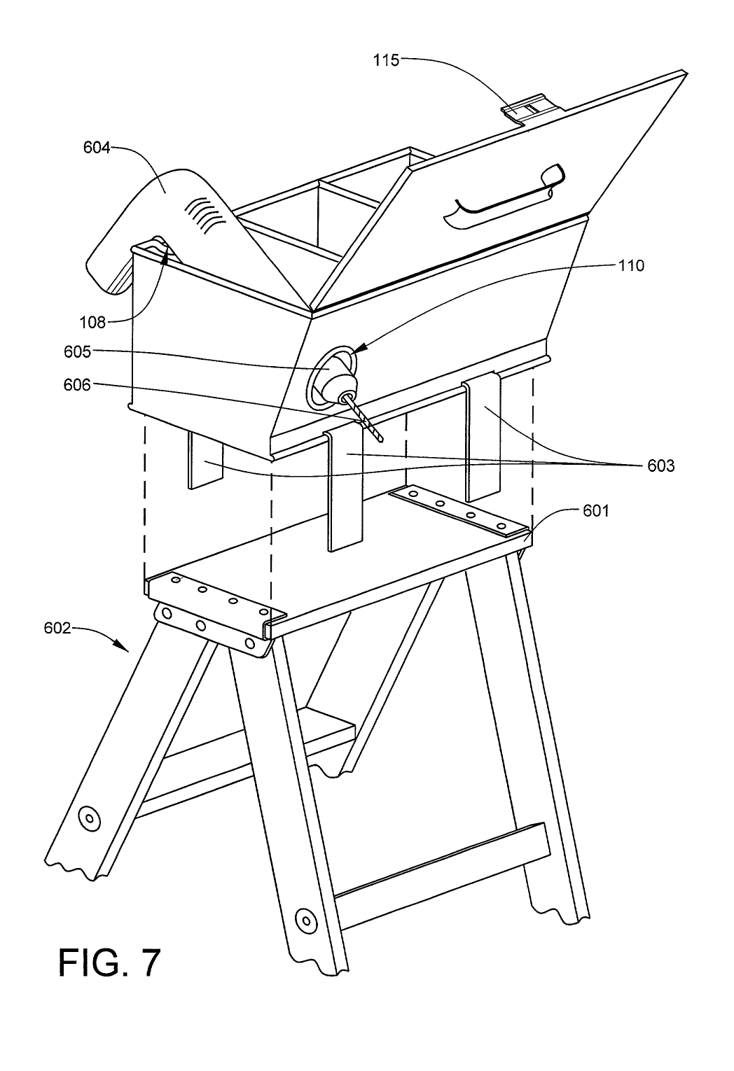

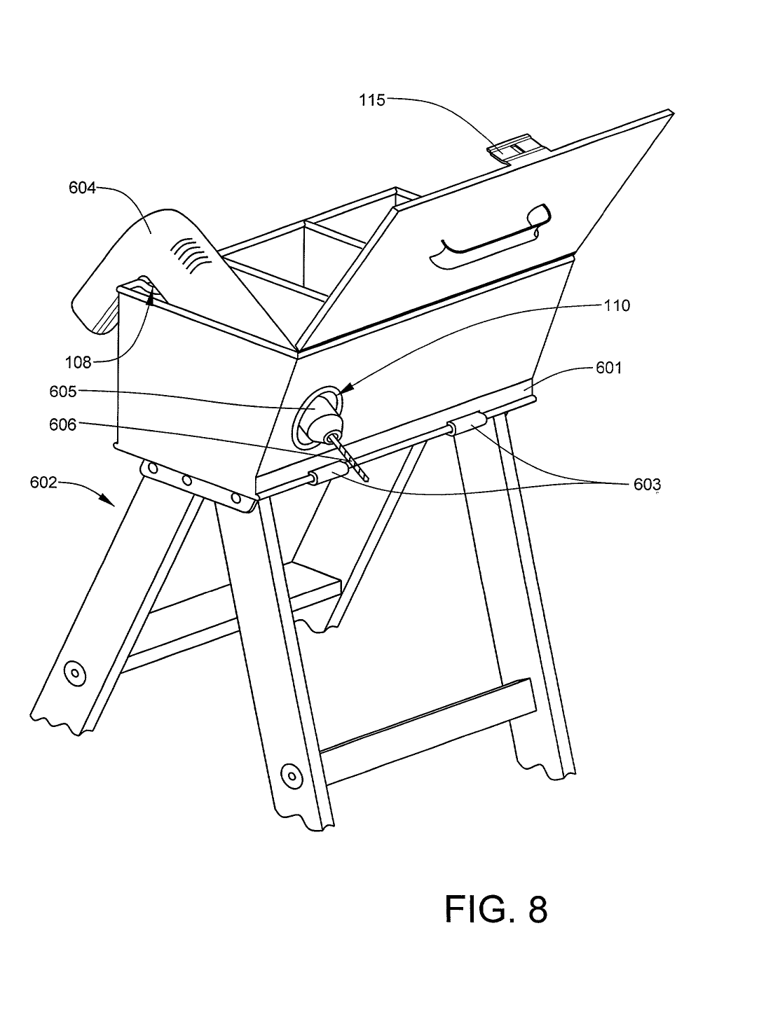

Referring now to FIG. 7, the toolbox 100 has been sized so that the base portion 101 fits over the uppermost step 601 of a folding step ladder 601, with the lower surface of floor panel 501 resting on the upper surface of the uppermost step 601. FIG. 7 shows the toolbox 100 positioned above step 601, while FIG. 8 shows the toolbox 100 mounted on step 601 and secured by straps 601.

Although only several embodiments of the invention are shown and described herein, it will be obvious to those having ordinary skill in the art that changes and modifications may be made thereto without departing from the scope and the spirit of the invention as hereinafter claimed.

What is claimed is:

1. A toolbox mountable on the top step of a step ladder, said toolbox comprising:
a base portion having at least one pair of horizontally-aligned slot-type apertures therein;
a storage portion integral with said base portion, said storage portion having a front panel, a rear panel, and a pair of opposed side panels which interconnect the front and rear panels at opposite ends thereof, and multiple interior panels, at least one of which is parallel to said side panels, said interior panels, in combination with said front, rear and side panels, forming multiple storage compartments within said storage portion;
a cover portion hingeably connected to an upper edge of said rear panel; and
at least one strap which is inserted through said at least one pair of slot-type apertures, said strap having a pair of ends which may be secured together beneath the top step in order to secure the toolbox thereto.

2. The toolbox of claim 1, wherein said rear panel is obliquely inclined so that an upper edge perimeter of said storage portion is larger than a bottom perimeter.

3. The toolbox of claim 1, wherein a rear panel portion of at least one of said storage compartments includes an aperture for receiving a chuck end of an electric tool.

4. The toolbox of claim 3, wherein an upper edge of a front panel portion of the storage compartment having an aperture has a notch in which the electric tool may rest.

5. The toolbox of claim 1, wherein said cover portion is connected to said upper edge via a live hinge.

6. The toolbox of claim 1, wherein said base portion, said storage portion, and said cover portion are formed as a single piece of injection molded semi-rigid polyethylene plastic material.

7. The toolbox of claim 1, wherein said base portion, said storage portion, and said cover portion are formed as injection molded components from a polymeric material selected from the group consisting of polyethylene, polypropylene, polycarbonate and polystyrene compounds.

8. A toolbox mountable on the top step of a step ladder, said toolbox comprising:
a base portion strapable to said top step;
a storage portion integral with said base portion, said storage portion having a front panel, a rear panel, and a pair of opposed side panels which interconnect the front and rear panels at opposite ends thereof, and multiple interior panels, at least one of which is parallel to said side panels, said interior panels, in combination with said front, rear and side panels, forming multiple storage compartments within said storage portion; and
a cover portion hingeably connected to an upper edge of said rear panel.

9. The toolbox of claim 8, wherein said rear panel is obliquely inclined so that an upper edge perimeter of said storage portion is larger than a bottom perimeter.

10. The toolbox of claim 8, wherein a rear panel portion of at least one of said storage compartments includes an aperture for receiving a chuck end of an electric tool.

11. The toolbox of claim 10, wherein an upper edge of a front panel portion of the storage compartment having an aperture has a notch in which the electric tool may rest.

12. The toolbox of claim 8, wherein said cover portion is connected to said upper edge via a live hinge.

13. The toolbox of claim 8, wherein said base portion, said storage portion, and said cover portion are formed as a single piece of injection molded semi-rigid polyethylene plastic material.

14. The toolbox of claim 8, wherein said base portion, said storage portion, and said cover portion are formed as injection molded components from a polymeric material selected from the group consisting of polyethylene, polypropylene, polycarbonate and polystyrene compounds.

15. The toolbox of claim 8, wherein said base portion includes two pair of spaced-apart horizontally-aligned slot-type apertures therein, and said toolbox further comprises a pair of straps, each of which is inserted through each pair of slot-type apertures, each strap having a pair of ends which may be secured together beneath the top step in order to secure the toolbox thereto.

16. A toolbox mountable on the top step of a step ladder, said toolbox comprising:
a base portion strapable to said top step;
a storage portion integral with said base portion, said storage portion having a front panel, a rear panel, and a pair of opposed side panels which interconnect the front and rear panels at opposite ends thereof, and multiple interior panels, at least one of which is parallel to said side panels, said interior panels, in combination with said front, rear and side panels, forming multiple storage compartments within said storage portion, at least one of said storage compartments having an obliquely and outwardly inclined rear panel portion which includes an aperture for receiving a chuck end of an electric tool and an upper edge of a front panel portion which includes a notch a portion of the electric tool spaced from said chuck.

17. The toolbox of claim 16, wherein said cover portion is connected to said upper edge via a live hinge.

18. The toolbox of claim 16, wherein said base portion, said storage portion, and said cover portion are formed as a single piece of injection molded semi-rigid polyethylene plastic material.

19. The toolbox of claim 16, wherein said base portion, said storage portion, and said cover portion are formed as injection molded components from a polymeric material selected from the group consisting of polyethylene, polypropylene, polycarbonate and polystyrene compounds.

20. The toolbox of claim 18, wherein said base portion is sized to fit over the uppermost step of the step ladder.
